(19) United States
(12) Patent Application Publication
(10) Pub. No.: US 2024/0242485 A1
(43) Pub. Date: Jul. 18, 2024

(54) METHOD, ELECTRONIC DEVICE, AND COMPUTER PROGRAM PRODUCT FOR GENERATING SEGMENTED IMAGES

(71) Applicant: Dell Products L.P., Round Rock, TX (US)

(72) Inventors: Zijia Wang, Weifang (CN); Zhisong Liu, Shenzhen (CN); Zhen Jia, Shanghai (CN)

(21) Appl. No.: 18/110,501

(22) Filed: Feb. 16, 2023

(30) Foreign Application Priority Data
Jan. 18, 2023 (CN) 202310075385.7

(51) Int. Cl. G06V 10/774; G06V 10/26; G06V 10/776

(52) U.S. Cl. CPC G06V 10/774; G06V 10/26; G06V 10/776

(57) ABSTRACT

Embodiments of the present disclosure relate to a method, an electronic device, and a computer program product for generating segmented images. The method includes inputting a to-be-processed image to a first generator, where the first generator is obtained from training by using a first discriminator for the first generator, a second generator, and a second discriminator for the second generator, and the first generator, the first discriminator, the second generator, and the second discriminator form a cycle generative adversarial network. The method further includes acquiring segmented images of the to-be-processed image that are generated by the first generator. By means of the method, segmented images with improved accuracy can be obtained, and training resources required in a process of training a generator can be greatly reduced, thereby improving the training speed and saving training resources.

### RELATED APPLICATION

The present application claims priority to Chinese Patent Application No. 202310075385.7, filed Jan. 18, 2023, and entitled “Method, Electronic Device, and Computer Program Product for Generating Segmented Images,” which is incorporated by reference herein in its entirety.

### FIELD

Embodiments of the present disclosure relate to the field of image processing, and more specifically, relate to a method, an electronic device, and a computer program product for generating segmented images.

### BACKGROUND

In recent years, deep learning has made breakthrough progress in many fields. A generative adversarial network (GAN) has become a very popular deep learning model in recent years. A GAN includes a generator and a discriminator, where the generator can capture distribution of sample data, and the discriminator is usually a binary classifier configured to determine whether input data is real data or generated data. The ongoing development of GANs has greatly advanced and promoted the research and application of unsupervised learning and image generation. Currently, GANs have been extended from the original synthesis of realistic images to various fields of computer vision such as image segmentation and style migration to generate segmented images, migration images, etc., and has received extensive attention.

### SUMMARY

Embodiments of the present disclosure provide a method, an electronic device, and a computer program product for generating segmented images.

According to a first aspect of the present disclosure, a method for generating segmented images is provided. The method includes inputting a to-be-processed image to a first generator, where the first generator is obtained from training by using a first discriminator for the first generator, a second generator, and a second discriminator for the second generator, and the first generator, the first discriminator, the second generator, and the second discriminator form a cycle generative adversarial network. The method further includes acquiring segmented images of the to-be-processed image that are generated by the first generator.

According to a second aspect of the present disclosure, an electronic device is provided. The electronic device comprises at least one processor; and a memory coupled to the at least one processor and having instructions stored thereon, where the instructions, when executed by the at least one processor, cause the electronic device to execute actions including: inputting a to-be-processed image to a first generator, wherein the first generator is obtained from training by using a first discriminator for the first generator, a second generator, and a second discriminator for the second generator, and the first generator, the first discriminator, the second generator, and the second discriminator form a cycle generative adversarial network; and acquiring segmented images of the to-be-processed image that are generated by the first generator.

According to a third aspect of the present disclosure, a computer program product is provided. The computer program product is tangibly stored on a non-transitory computer-readable medium and includes machine-executable instructions, where the machine-executable instructions, when executed by a machine, cause the machine to perform steps of the method in the first aspect of the present disclosure.

### BRIEF DESCRIPTION OF THE DRAWINGS

By more detailed description of example embodiments of the present disclosure, provided herein with reference to the accompanying drawings, the above and other objectives, features, and advantages of the present disclosure will become more apparent, where identical reference numerals generally represent identical components in the example embodiments of the present disclosure.

FIG. 1 is a schematic diagram of an example environment in which a device and/or a method according to embodiments of the present disclosure can be implemented;

FIG. 2 is a flow chart of a method for generating segmented images according to embodiments of the present disclosure;

FIG. 3A is an example diagram of a to-be-processed image according to an embodiment of the present disclosure;

FIG. 3B is an example diagram of a generated segmented image according to an embodiment of the present disclosure;

FIG. 4 is a schematic block diagram of an architecture of a cycle generative adversarial network according to embodiments of the present disclosure;

FIG. 5 is a schematic block diagram of an architecture for pre-training a cycle generative adversarial network according to embodiments of the present disclosure; and

FIG. 6 is a schematic block diagram of an example device suitable for implementing embodiments of the present disclosure.

In the accompanying drawings, identical or corresponding numerals represent identical or corresponding parts.

### DETAILED DESCRIPTION

Illustrative embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the protection scope of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

Currently, a generative adversarial network has been extended from the original synthesis of realistic images to various fields of computer vision such as image segmentation and style migration, to generate segmented images, migration images, etc. However, in a case of applying a generative adversarial network to the fields with a relatively small number of training samples (such as automatic driving and agriculture fields), how to use a relatively small number of training samples to train the generative adversarial network to achieve accurate image segmentation has become a problem to be solved.

To at least solve the above and other potential problems, embodiments of the present disclosure provide a method for generating segmented images. The method includes inputting a to-be-processed image to a first generator, where the first generator is obtained from training by using a first discriminator for the first generator, a second generator, and a second discriminator for the second generator, and the first generator, the first discriminator, the second generator, and the second discriminator form a cycle generative adversarial network. The method further includes acquiring segmented images of the to-be-processed image that are generated by the first generator. By means of the method, segmented images with higher accuracy can be obtained. Moreover, by using the cycle generative adversarial network for training, a small number of training sample images can be used to realize the training of the generative adversarial network, which can greatly save training resources and significantly improve the training speed in a process of training a generator.

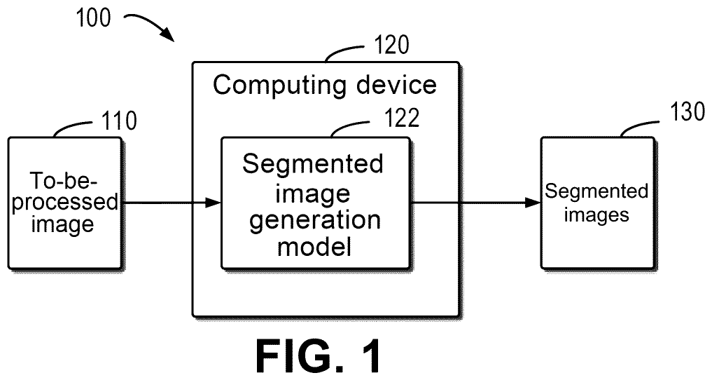

Embodiments of the present disclosure will be further described in detail with reference to the accompanying drawings below. FIG. 1 is a schematic diagram of example environment 100 in which embodiments of the present disclosure can be implemented.

Example environment 100 includes computing device 120, and computing device 120 includes segmented image generation model 122. Segmented image generation model 122 may be a trained segmented image generation model. In some implementations, the segmented image generation model includes a generative adversarial network, also referred to herein as a GAN. More particularly, the segmented image generation model 122 includes a cycle generative adversarial network. Computing device 120 is used for receiving to-be-processed image 110 and processing to-be-processed image 110 by means of segmented image generation model 122 so as to generate and obtain segmented images 130 corresponding to to-be-processed image 110, such as the generated segmented images.

In addition, it can be understood that for the sake of simplicity, segmentation of a to-be-processed image by a computing device using a segmented image generation model, that is, the process of generating segmented images of the to-be-processed image, will be described below in combination with the accompanying drawings, but this is only illustrative. The computing device of the present disclosure can also obtain a style migration image generation model by receiving style migration sample images during the training process and adopting the training method according to embodiments of the present disclosure, thereby realizing generating a style migration image corresponding to the to-be-processed image. This is not limited in the present disclosure.

In environment 100, to-be-processed image 110 may be obtained by various types of image acquisition devices. The image acquisition devices can be integrated with computing device 120, and can also be separated from computing device 120. To-be-processed image 110 may include images collected in real time by the image acquisition devices integrated in computing device 120, may also include images received via a network or other transmission media, and may further include images read by accessing various storage media. The present disclosure does not limit sources of to-be-processed image 110.

In some embodiments, segmented image generation model 122 may be a trained model (e.g., a generative adversarial network model) for processing to-be-processed image 110 and generating segmented images 130 of the to-be-processed image.

Computing device 120 may include, but is not limited to, a personal computer, a server computer, a handheld or laptop device, a mobile device (such as a mobile phone, a personal digital assistant (PDA), and a media player), a multi-processor system, a consumer electronic product, a wearable electronic device, an intelligent home device, a minicomputer, a mainframe computer, an edge computing device, a distributed computing environment including any of the above systems or devices, etc.

In some implementations, computing device 120 may receive to-be-processed image 110. Computing device 120 includes segmented image generation model 122. Segmented image generation model 122 may be a trained generative adversarial model and include a first generator. Segmented image generation model 122 may input to-be-processed image 110 to the first generator and acquire segmented images 130 of to-be-processed image 110 that are generated by the first generator. In some implementations, the first generator is obtained from training by using a first discriminator for the first generator, a second generator, and a second discriminator for the second generator, and the first generator, the first discriminator, the second generator, and the second discriminator form a cycle generative adversarial network.

It is advantageous that the trained segmented image generation model according to embodiments of the present disclosure can generate more accurate segmented images for image segmentation tasks. Moreover, the method of generating images according to embodiments of the present disclosure reduces the number of training sample images used for training the segmented image generation model, and reduces the computation requirements of tasks. Therefore, the image generation method according to embodiments of the present disclosure can also be deployed in an edge device to generate segmented images with higher security, lower latency, and higher reliability.

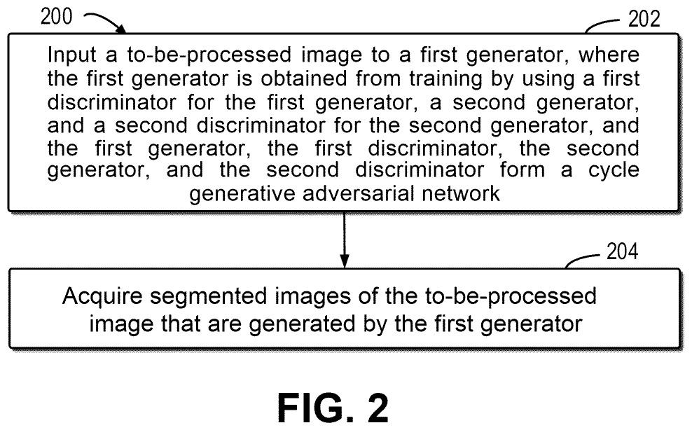

A block diagram of example environment 100 in which embodiments of the present disclosure can be implemented is described above with reference to FIG. 1. A flow chart of method 200 for generating images according to embodiments of the present disclosure is described below with reference to FIG. 2. Method 200 may be executed at computing device 120 in FIG. 1 or at any suitable computing device.

At block 202, computing device 120 may input to-be-processed image 110 to a first generator. In some embodiments, the first generator may be located in segmented image generation model 122. Moreover, in some implementations, the first generator is obtained from training by using a first discriminator for the first generator, a second generator, and a second discriminator for the second generator, and the first generator, the first discriminator, the second generator, and the second discriminator form a cycle generative adversarial network. The formed cycle generative adversarial network may be located in segmented image generation model 122. A process of training the first generator by using the cycle generative adversarial network will be described in detail below.

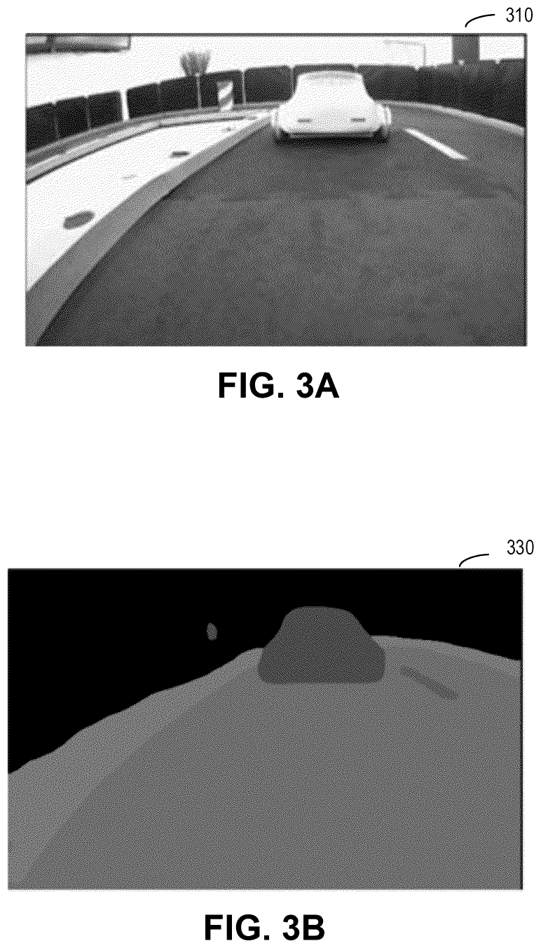

An example in which computing device 120 applies segmented image generation model 122 to the field of image segmentation is taken for illustration. FIG. 3A is an example of to-be-processed image 310. In the example to-be-processed image, multiple target objects are included. For example, to-be-processed image 310 includes targets of multiple categories such as vehicle, road, traffic line on the road, shoulder, obstacle, and so on. It should be understood that the example image in FIG. 3A is merely illustrative, and the present disclosure does not limit the specific content of to-be-processed image 110.

At block 204, computing device 120 may acquire segmented images 130 of to-be-processed image 110 that is generated by the first generator. An example in which computing device 120 applies segmented image generation model 122 to the field of image segmentation is still taken for illustration. In a case where the first generator receives to-be-processed image 310 as shown in FIG. 3A, segmented image generation model 122 may process categories in to-be-processed image 310 so as to generate one or more segmented images 330, as shown in FIG. 3B.

By means of the method for generating segmented images according to embodiments of the present disclosure, more accurate segmented images can be obtained. Moreover, by means of the method, the number of training sample images required for training the segmented image generation model is reduced, and the computation requirements of tasks are lowered. Therefore, the image generation method according to embodiments of the present disclosure can also be deployed in an edge device to generate segmented images with higher security, lower latency, and higher reliability.

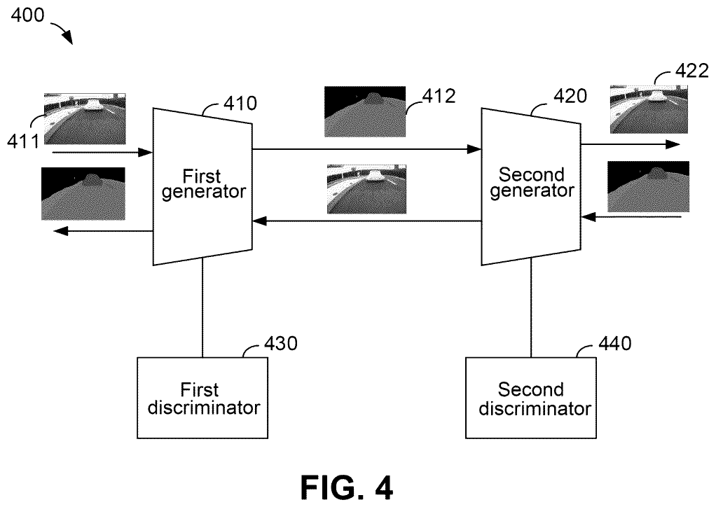

FIG. 4 is a schematic block diagram of an architecture of a cycle generative adversarial network 400 according to embodiments of the present disclosure. Cycle generative adversarial network 400 includes first generator 410, second generator 420, first discriminator 430 for first generator 410, and second discriminator 440 for second generator 420. In some implementations, computing device 120 (or other computing devices) may use cycle generative adversarial network 400 to train first generator 410. For example, computing device 120 (or other computing device) may train first generator 410, first discriminator 430, second generator 420, and second discriminator 440 simultaneously to obtain trained cycle generative adversarial network 400, so as to further obtain trained first generator 410 for generating segmented images of a to-be-processed image.

After cycle generative adversarial network 400 is trained, trained cycle generative adversarial network 400 can be obtained. Hence, first generator 410 may receive to-be-processed image 411 and generate segmented images 412 of the to-be-processed image. In addition, computing device 120 may further input segmented images 412 to trained second generator 420 so as to generate reconstructed image 422 of to-be-processed image 411 via second generator 420, as shown in FIG. 4. In some implementations, reconstructed image 422 and to-be-processed image 411 belong to the same image field. Hence, reconstructing the to-be-processed image by using second generator 420 can also obtain more paired sample data for training other neural network models, which is especially beneficial when the number of samples is small.

A process of training cycle generative adversarial network 400 will be described in detail below with reference to FIG. 4. In some embodiments, a device for training cycle generative adversarial network 400 (which is called a “training device” for short (which may include computing device 120 or other computing devices)) may receive labeled sample image Image_{U}, sample segmented image Image_{Lseg} corresponding to labeled sample image Image_{U}, and unlabeled sample image Image_{U}. In some implementations, labeled sample image Image_{L}, may be a corresponding labeled image of unlabeled sample image Image_{U}. A training device inputs received various sample images to to-be-trained cycle generative adversarial network 400, so as to construct integrated training loss function LOSSₜₒₜₐₗ based on labeled sample image Image_{L}, sample segmented image Image_{Lseg} corresponding to labeled sample image Image_{L}, and unlabeled sample image Image_{U}, and train cycle generative adversarial network 400 based on integrated training loss function LOSSₜₒₜₐₗ.

In some implementations, integrated training loss function LOSSₜₒₜₐₗ includes supervised segmentation loss function Lossₛᵤₚ constructed by the training device by using first generator 410 and second generator 420, cycle consistency loss function Loss_{cycle} constructed by using first generator 410 and second generator 420, and adversarial loss function Loss_{adv} constructed by using first generator 410, second generator 420, first discriminator 430, and second discriminator 440. In some implementations, integrated training loss function LOSSₜₒₜₐₗ may be the difference between the sum of supervised segmentation loss function Lossₛᵤₚ and cycle consistency loss function Loss_{cycle} and adversarial loss function Loss_{adv}. In other words, a value of integrated training loss function LOSSₜₒₜₐₗ decreases with the increase of a value of adversarial loss function Loss_{adv}.

In some embodiments, first generator 410 receives labeled sample image Image_{L}, and generates output segmented images Image_{Lseg-output} based on labeled sample image Image_{L}. The training device constructs first supervised segmentation loss function Lossₛᵤₚ₁ based on the correlation between output segmented image Image_{Lseg-output} of first generator 410 and sample segmented image Image_{Lseg} corresponding to labeled sample image Image_{U}. In some embodiments, second generator 420 receives sample segmented image Image_{Lseg}, and generates output image Imageₒᵤₜₚᵤₜ based on sample segmented image Image_{Lseg}. The training device constructs second supervised segmentation loss function LOSSₛᵤₚ₂ based on a difference between output image Imageₒᵤₜₚᵤₜ of second generator 420 and labeled sample image Image_{L} corresponding to sample segmented image Image_{Lseg}. The training device may construct supervised segmentation loss function Lossₛᵤₚ based on first supervised segmentation loss function Lossₛᵤₚ₁ and second supervised segmentation loss function LOSSₛᵤₚ₂. For example, supervised segmentation loss function Lossₛᵤₚ may be a weighted sum of first supervised segmentation loss function Lossₛᵤₚ₁ and second supervised segmentation loss function Lossₛᵤₚ₂. There can also be other construction methods, which are not limited in the present disclosure.

Cycle consistency loss function Loss_{cycle} is associated with a difference between image Image₁ and reconstructed image Image_{Iconstruct} obtained after image Image₁ is processed by first generator 410 and second generator 420. In some implementations, the training device may construct first cycle consistency loss function Loss_{cycle1} by using first generator 410 and second generator 420 and based on unlabeled sample image Image_{U}. The training device may construct second cycle consistency loss function Loss_{cycle2} by using first generator 410 and second generator 420 and based on sample segmented image Image_{Lseg}. The training device may further construct cycle consistency loss function Loss_{cycle} based on first cycle consistency loss function Loss_{cycle1} and second cycle consistency loss function Loss_{cycle2}. For example, the training device may construct cycle consistency loss function Loss_{cycle} based on a weighted sum of first cycle consistency loss function Loss_{cycle1} and second cycle consistency loss function Loss_{cycle2}.

For example, first generator 410 may receive unlabeled sample image Image_{U} and generate first output image Image_{U-output1} based on unlabeled sample image Image_{U}. Second generator 420 receives first output image Image_{U-ouput1} and generates second output image Image_{U-output2} based on first output image Image_{U-oupu1}. The training device may construct first cycle consistency loss function Loss_{cycle1} based on a difference between second output image Image_{U-ouput2} and unlabeled sample image Image_{U}. In addition, second generator 420 may receive sample segmented image Image_{Lseg} and generate third output image Image_{Lseg-ouput3} based on sample segmented image Image_{Lseg}. First generator 410 receives third output image Image_{Lseg-ouput3} and generates fourth output image Image_{Lseg-ouput4} based on third output image Image_{Lseg-ouput3}. The training device may construct second cycle consistency loss function Loss_{cycle2} based on the correlation between sample segmented image Image_{Lseg} and fourth output image Image_{Lseg-ouput4}. The training device may further construct cycle consistency loss function Loss_{cycle} based on first cycle consistency loss function Loss_{cycle1} and second cycle consistency loss function Loss_{cycle2}. For example, the training device may construct cycle consistency loss function Loss_{cycle} based on a weighted sum of first cycle consistency loss function Loss_{cycle1} and second cycle consistency loss function Loss_{cycle2}.

In some implementations, the training device may construct first adversarial loss function LOSS_{adv1} by using first discriminator 430 and first generator 410 and based on sample segmented image Image_{Lseg} and unlabeled sample image Image_{U}. The training device may construct second adversarial loss function LOSS_{adv1} by using second discriminator 440 and second generator 420 and based on sample segmented image Image_{Lseg} and unlabeled sample image Image_{U}. The training device may further construct adversarial loss function Loss_{adv} based on first adversarial loss function Loss_{adv1} and second adversarial loss function Loss_{adv2}. For example, the training device may construct adversarial loss function Loss_{adv} based on a weighted sum of first adversarial loss function Loss_{adv1} and second adversarial loss function Loss_{adv2}.

In some implementations, first generator 410 may receive unlabeled sample image Image_{U} and generate output image Image_{U-ouput} based on unlabeled sample image Image_{U} (in some embodiments, because first generator 410, first discriminator 430, second generator 420, and second discriminator 440 are trained simultaneously, output image Image_{U-ouput} may be the same as first output image Image_{U-ouput1} mentioned above). For an input image (for example, output image Image_{U-ouput} of first generator 410), first discriminator 430 may predict first probability P1 that the input image is output image Image_{U-ouput} generated by first generator 410 and second probability P2 that the image is a real image (for example, it may correspond to sample segmented image Image_{Lseg} here). The training device may construct first adversarial loss function Loss_{adv1} based on first probability P1 and second probability P2.

Similarly, second generator 420 may receive sample segmented image Image_{Lseg} and generate sample segmentation output image Image_{Lseg-ouput} based on sample segmented image Image_{Lseg} (in some embodiments, because first generator 410, first discriminator 430, second generator 420, and second discriminator 440 can be trained simultaneously, sample segmentation output image Image_{Lseg-ouput} may be the same as third output image Image_{Lseg-ouput3} mentioned above). For an input image (for example, sample segmentation output image Image_{Lseg-ouput} of second generator 420), second discriminator 440 may predict third probability P3 that the input image is sample segmentation output image Image_{Lseg-ouput} generated by second generator 420 and fourth probability P4 that the image is a real image (for example, unlabeled sample image Image_{U}). The training device may construct second adversarial loss function Loss_{adv2} based on third probability P3 and fourth probability P4.

The training device may further construct adversarial loss function Loss_{adv} based on first adversarial loss function Loss_{adv1} and second adversarial loss function Loss_{adv2}. For example, the training device may construct adversarial loss function Loss_{adv} based on a weighted sum of first adversarial loss function Loss_{adv1} and second adversarial loss function Loss_{adv2}.

Correspondingly, the training device constructs integrated training loss function LOSSₜₒₜₐₗ according to supervised segmentation loss function Lossₛᵤₚ, cycle consistency loss function Loss_{cycle}, and adversarial loss function Loss_{adv}, and trains cycle generative adversarial network 400 based on integrated training loss function LOSSₜₒₜₐₗ.

By means of the above training method according to embodiments of the present disclosure, a quantity of samples and computation resources required for training can be greatly reduced, thereby reducing the quantity of data processing of sample images required during training. Therefore, the training speed can be significantly improved, and training sources can be saved.

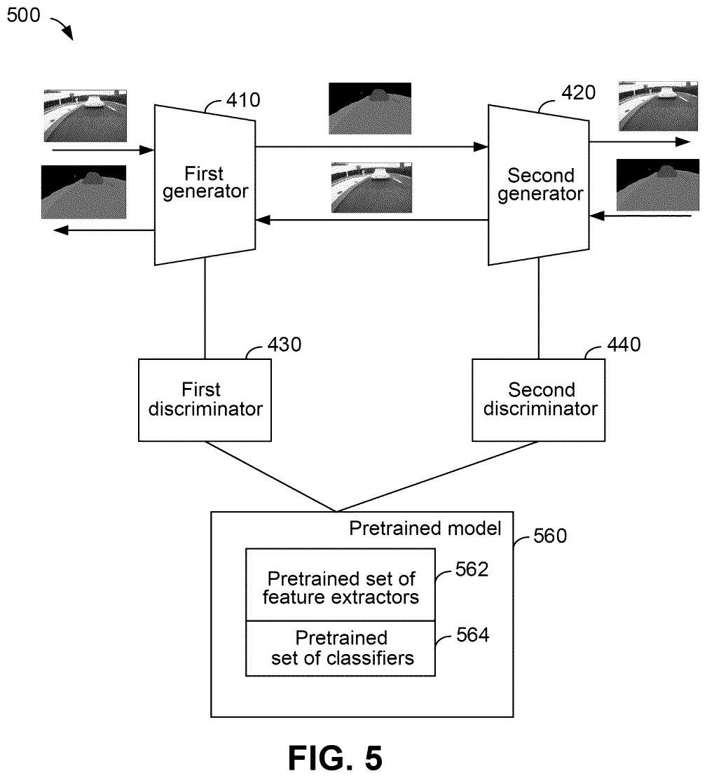

In some implementations, in order to further improve the training speed and reduce the number of samples required for training, before training first generator 410 by using the cycle generative adversarial network 400, first generator 410, second generator 420, first discriminator 430, and second discriminator 440 can be pre-trained. A pre-training process will be described with reference to FIG. 5. FIG. 5 is a schematic block diagram of architecture 500 for pre-training a cycle generative adversarial network according to embodiments of the present disclosure. Similar components in FIG. 5 and FIG. 4 are named with the same reference numerals and have similar functions and actions. For the sake of simplicity, description of these same components will not be repeated.

As shown in FIG. 5, besides to-be-trained first generator 410, to-be-trained second generator 420, to-be-trained first discriminator 430, and to-be-trained second discriminator 440, architecture 500 for pre-training a cycle generative adversarial network further includes pre-trained model 560 for pre-training the cycle generative adversarial network. In some implementations, pre-trained model 560 may include pre-trained set of feature extractors 562 and pre-trained set of classifiers 564, and each feature extractor of pre-trained set of feature extractors 562 is correspondingly cascaded with each classifier in pre-trained set of classifiers 564.

In some implementations, first discriminator 430 and first generator 410 may be pre-trained based on a set of feature extractors in pre-trained set of feature extractors 562 and a corresponding set of classifiers in pre-trained set of classifiers 564. Moreover, when training the first discriminator, parameters in the set of feature extractors are fixed. For example, parameters in the set of feature extractors can be fixed. Pre-trained first discriminator 430 is obtained by adjusting parameters of first discriminator 430 and parameters in the corresponding set of classifiers. After obtaining pre-trained first discriminator 430, a training device may continue to train first generator 410 so as to obtain pre-trained first generator 410 and subsequently obtain trained first generator 410 by means of cycle generative adversarial network 400 according to the above training method and architecture 500.

Similarly, second discriminator 440 and second generator 420 can be pre-trained based on the set of feature extractors in pre-trained set of feature extractors 562 and a corresponding set of classifiers in pre-trained set of classifiers 564. Moreover, when training the second discriminator, parameters in the set of feature extractors are fixed. For example, parameters in the set of feature extractors can be fixed. Pre-trained second discriminator 440 is obtained by adjusting parameters of second discriminator 440 and parameters in the corresponding set of classifiers. After obtaining pre-trained second discriminator 440, the training device may continue to train second generator 420 so as to obtain pre-trained second generator 420 and subsequently further train first generator 410 by means of cycle generative adversarial network 400 according to the above training method and architecture 500.

In some implementations, first discriminator 430 and second discriminator 440 may be pre-trained simultaneously by using pre-trained model 560. The present disclosure does not define an order of pre-training first discriminator 430 and second discriminator 440.

To-be-trained first generator 410, to-be-trained second generator 420, to-be-trained first discriminator 430, and to-be-trained second discriminator 440 in cycle generative adversarial network 400 are pre-trained by using pre-trained model 560, so as to obtain corresponding pre-trained first generator 410, pre-trained second generator 420, pre-trained first discriminator 430, and pre-trained second discriminator 440, thereby improving the quality and effect of segmented images generated by pre-trained first generator 410 and further reducing the number of samples and computation resources required for training the cycle generative adversarial network. Therefore, the training speed can be further improved, and the requirement for the number of samples during the training can be reduced so as to further save training resources.

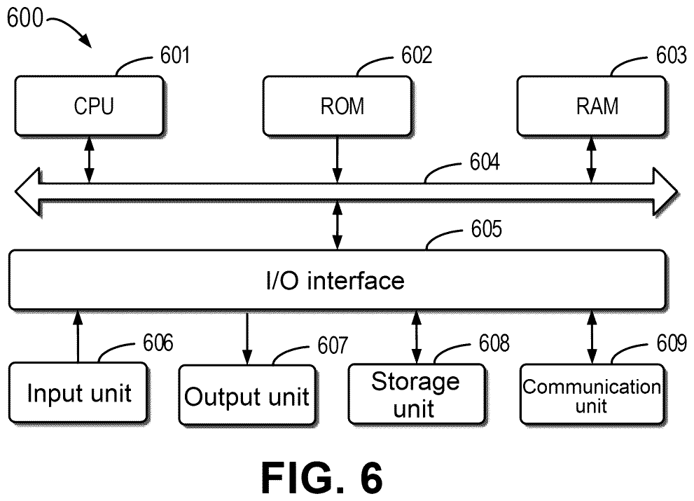

FIG. 6 is a schematic block diagram of example device 600 that may be used to implement embodiments of the present disclosure. Computing device 120 in FIG. 1 can be implemented using device 600. As shown in the figure, device 600 includes central processing unit (CPU) 601 that may execute various appropriate actions and processing according to computer program instructions stored in read-only memory (ROM) 602 or computer program instructions loaded from storage unit 608 to random access memory (RAM) 603. Various programs and data required for the operation of device 600 may further be stored in RAM 603. CPU 601, ROM 602, and RAM 603 are connected to each other through bus 604. Input/output (I/O) interface 605 is also connected to bus 604.

A plurality of components in device 600 are connected to I/O interface 605, including: input unit 606, such as a keyboard and a mouse; output unit 607, such as various types of displays and speakers; storage unit 608, such as a magnetic disk and an optical disc; and communication unit 609, such as a network card, a modem, and a wireless communication transceiver. Communication unit 609 allows device 600 to exchange information/data with other devices via a computer network, such as the Internet, and/or various telecommunication networks.

The various processes and processing described above, such as method 200 for acquiring an image and related processes, may be performed by CPU 601. For example, in some embodiments, method 200 for generating images and related processes thereof may be implemented as a computer software program that is tangibly included in a machine-readable medium, such as storage unit 608. In some embodiments, part of or all the computer program may be loaded and/or installed onto device 600 via ROM 602 and/or communication unit 609. One or more actions of method 200 for generating segmented images and related processes thereof described above may be performed when the computer program is loaded into RAM 603 and executed by CPU 601.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions. Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method for generating segmented images, wherein the method comprises:
inputting a to-be-processed image to a first generator, wherein the first generator is obtained from training by using a first discriminator for the first generator, a second generator, and a second discriminator for the second generator, and the first generator, the first discriminator, the second generator, and the second discriminator form a cycle generative adversarial network; and
acquiring segmented images of the to-be-processed image that are generated by the first generator.

2. The method according to claim 1, wherein before training the first generator by using the cycle generative adversarial network, the first discriminator and the first generator are obtained from pre-training based on a pre-trained set of feature extractors and a corresponding set of classifiers, and when training the first discriminator, parameters in the set of feature extractors are fixed.

3. The method according to claim 2, wherein before training the first generator by using the cycle generative adversarial network, the second discriminator and the second generator are obtained from pre-training based on the pre-trained set of feature extractors and the corresponding set of classifiers, and when training the second discriminator, parameters in the set of feature extractors are fixed.

4. The method according to claim 1, further comprising:
inputting the segmented images to the second generator so as to generate a reconstructed image of the to-be-processed image by the second generator; and
acquiring the reconstructed image of the to-be-processed image that is generated by the second generator.

5. The method according to claim 1, wherein training the first generator by using the cycle generative adversarial network comprises:
training the first generator, the first discriminator, the second generator, and the second discriminator simultaneously so as to obtain the trained cycle generative adversarial network.

6. The method according to claim 1, wherein training the first generator by using the cycle generative adversarial network comprises:
acquiring a labeled sample image, a sample segmented image corresponding to the labeled sample image, and an unlabeled sample image;
constructing an integrated training loss function based on the labeled sample image, the sample segmented image, and the unlabeled sample image; and
training the cycle generative adversarial network based on the integrated training loss function.

7. The method according to claim 6, wherein the integrated training loss function comprises a supervised segmentation loss function constructed by using the first generator and the second generator, a cycle consistency loss function constructed by using the first generator and the second generator, and an adversarial loss function constructed by using the first generator, the second generator, the first discriminator, and the second discriminator.

8. The method according to claim 7, wherein a value of the integrated training loss function decreases with an increase in a value of the adversarial loss function.

9. The method according to claim 7, wherein the cycle consistency loss function is constructed in the following manner:
constructing a first cycle consistency loss function by using the first generator and the second generator and based on the unlabeled sample image;
constructing a second cycle consistency loss function by using the first generator and the second generator and based on the sample segmented image; and
constructing the cycle consistency loss function based on the first cycle consistency loss function and the second cycle consistency loss function.

10. The method according to claim 7, wherein the adversarial loss function is constructed in the following manner:
constructing a first adversarial loss function by using the first discriminator and the first generator and based on the sample segmented image and the unlabeled sample image;
constructing a second adversarial loss function by using the second discriminator and the second generator and based on the sample segmented image and the unlabeled sample image; and
constructing the adversarial loss function based on the first adversarial loss function and the second adversarial loss function.

11. An electronic device, comprising:
at least one processor; and
at least one memory, the at least one memory being coupled to the at least one processor and storing instructions used for execution by the at least one processor, wherein when executed by the at least one processor, the instructions cause the electronic device to perform actions comprising:
inputting a to-be-processed image to a first generator, wherein the first generator is obtained from training by using a first discriminator for the first generator, a second generator, and a second discriminator for the second generator, and the first generator, the first discriminator, the second generator, and the second discriminator form a cycle generative adversarial network; and
acquiring segmented images of the to-be-processed image that are generated by the first generator.

12. The electronic device according to claim 11, wherein before training the first generator by using the cycle generative adversarial network, the first discriminator and the first generator are obtained from pre-training based on a pre-trained set of feature extractors and a corresponding set of classifiers, and when training the first discriminator, parameters in the set of feature extractors are fixed.

13. The electronic device according to claim 12, wherein before training the first generator by using the cycle generative adversarial network, the second discriminator and the second generator are obtained from pre-training based on the pre-trained set of feature extractors and the corresponding set of classifiers, and when training the second discriminator, parameters in the set of feature extractors are fixed.

14. The electronic device according to claim 11, wherein the instructions, when executed by the at least one processor, further causes the electronic device to perform actions comprising:
inputting the segmented images to the second generator so as to generate a reconstructed image of the to-be-processed image by the second generator; and
acquiring the reconstructed image of the to-be-processed image that is generated by the second generator.

15. The electronic device according to claim 11, wherein training the first generator by using the cycle generative adversarial network comprises:
training the first generator, the first discriminator, the second generator, and the second discriminator simultaneously so as to generate the trained cycle generative adversarial network.

16. The electronic device according to claim 11, wherein training the first generator by using the cycle generative adversarial network comprises:
acquiring a labeled sample image, a sample segmented image corresponding to the labeled sample image, and an unlabeled sample image;
constructing an integrated training loss function based on the acquired labeled sample image, the sample segmented image, and the unlabeled sample image; and
training the cycle generative adversarial network based on the integrated training loss function.

17. The electronic device according to claim 16, wherein the integrated training loss function comprises a supervised segmentation loss function constructed by using the first generator and the second generator, a cycle consistency loss function constructed by using the first generator and the second generator, and an adversarial loss function constructed by using the first generator, the second generator, the first discriminator, and the second discriminator.

18. The electronic device according to claim 17, wherein the cycle consistency loss function is constructed in the following manner:
constructing a first cycle consistency loss function by using the first generator and the second generator and based on the unlabeled sample image;
constructing a second cycle consistency loss function by using the first generator and the second generator and based on the sample segmented image; and
constructing the cycle consistency loss function based on the first cycle consistency loss function and the second cycle consistency loss function.

19. The electronic device according to claim 17, wherein the adversarial loss function is constructed in the following manner:
constructing a first adversarial loss function by using the first discriminator and the first generator and based on the sample segmented image and the unlabeled sample image;
constructing a second adversarial loss function by using the second discriminator and the second generator and based on the sample segmented image and the unlabeled sample image; and
constructing the adversarial loss function based on the first adversarial loss function and the second adversarial loss function.

20. A computer program product tangibly stored on a non-transitory computer-readable medium and comprising machine-executable instructions, wherein the machine-executable instructions, when executed by a machine, cause the machine to perform the following steps:
inputting a to-be-processed image to a first generator, wherein the first generator is obtained from training by using a first discriminator for the first generator, a second generator, and a second discriminator for the second generator, and the first generator, the first discriminator, the second generator, and the second discriminator form a cycle generative adversarial network; and
acquiring segmented images of the to-be-processed image that are generated by the first generator.
